(19) United States
(12) Patent Application Publication
(10) Pub. No.: US 2016/0189355 A1
(43) Pub. Date: Jun. 30, 2016

(54) USER CONTROLS FOR DEPTH BASED IMAGE EDITING OPERATIONS

(71) Applicant: Dell Products, LP, Round Rock, TX (US)

(72) Inventors: Todd Basche, Los Altos, CA (US); Jeyprakash Michaelraj, San Jose, CA (US)

(21) Appl. No.: 14/584,761

(22) Filed: Dec. 29, 2014

(51) Int. Cl. G06T 5/20; G06F 3/0481; H04N 1/21; G06F 3/041; G06T 7/40

(52) U.S. Cl. CPC G06T 5/20; G06F 3/041; G06T 7/408; H04N 1/2112; G06F 3/0481; G06T 2207/20092; G06T 2207/10144; G06T 2207/10024

(57) ABSTRACT

A method, information handling system, and article of manufacture providing receiving a touch input from a touch screen display, determining a first axial motion element of the touch input, selecting a first depth image from a plurality of depth images in response to the first axial motion element, determining a second axial motion element of the touch input, selecting additional depth images of the plurality of depth images proximate in depth to the first depth image in response to the second axial motion element, applying an image processing filter to the first depth image and the additional depth images, combining the first depth image and the additional depth images filtered by the image processing filter with other depth images of the plurality of depth images not filtered by the image processing filter to obtain a display image, and displaying the display image on the touch screen display.

### FIELD OF THE DISCLOSURE

The present disclosure generally relates to information handling systems, and more particularly relates to image processing.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a display image diagram illustrating a graphic user interface (GUI) for receiving a touch input from a touch screen display and for displaying a display image on the touch screen display according to an embodiment of the present disclosure;

FIG. 3 is a flow diagram illustrating a method of filtering a portion of a plurality of depth images to obtain a display image according to an embodiment of the present disclosure; and

FIG. 4 is a block diagram illustrating a plurality of depth images and their relative spatial relationships according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

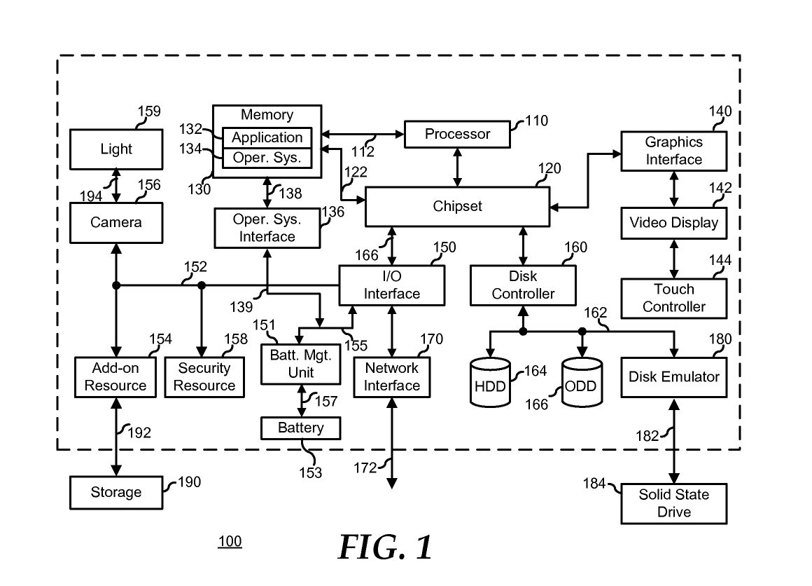

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processor 110, a chipset 120, a memory 130, a graphics interface 140, a disk controller 160, a disk emulator 180, an input/output (I/O) interface 150, and a network interface 170. Processor 110 is connected to chipset 120 via processor interface 112. Processor 110 is connected to memory 130 via memory bus 118. Memory 130 is connected to chipset 120 via a memory bus 122. Graphics interface 140 is connected to chipset 110 via a graphics interface 114, and provides a video display output 146 to a video display 142. Video display 142 is connected to touch controller 144 via touch controller interface 148. In a particular embodiment, information handling system 100 includes separate memories that are dedicated to processor 110 via separate memory interfaces. An example of memory 130 includes random access memory (RAM) such as static RAM (SRAM), dynamic RAM (DRAM), non-volatile RAM (NV-RAM), or the like, read only memory (ROM), another type of memory, or a combination thereof. Memory 130 can store, for example, at least one application 132 and operating system 134. Operating system 134 includes operating system code operable to detect resources within information handling system 100, to provide drivers for the resources, initialize the resources, to access the resources, and to support execution of the at least one application 132. Operating system 134 has access to system elements via an operating system interface 136. Operating system interface 136 is connected to memory 130 via connection 138.

Battery management unit (BMU) 151 is connected to I/O interface 150 via battery management unit interface 155. BMU 151 is connected to battery 153 via connection 157. Operating system interface 136 has access to BMU 151 via connection 139, which is connected from operating system interface 136 to battery management unit interface 155.

Graphics interface 140, disk controller 160, and I/O interface 150 are connected to chipset 120 via interfaces that may be implemented, for example, using a Peripheral Component Interconnect (PCI) interface, a PCI-Extended (PCI-X) interface, a high-speed PCI-Express (PCIe) interface, another industry standard or proprietary communication interface, or a combination thereof. Chipset 120 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof.

Disk controller 160 is connected to chipset 120 via connection 116. Disk controller 160 includes a disk interface 162 that connects the disc controller to a hard disk drive (HDD) 164, to an optical disk drive (ODD) 166, and to disk emulator 180. An example of disk interface 162 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 180 permits a solid-state drive 184 to be connected to information handling system 100 via an external interface 182. An example of external interface 182 includes a USB interface, an IEEE 1194 (Firewire) interface, a proprietary interface, or a combination thereof. Alternatively, solid-state drive 184 can be disposed within information handling system 100.

I/O interface 150 is connected to chipset 120 via connection 166. I/O interface 150 includes a peripheral interface 152 that connects the I/O interface to an add-on resource 154, to camera 156, and to a security resource 158. Peripheral interface 152 can be the same type of interface as connects graphics interface 140, disk controller 160, and I/O interface 150 to chipset 120, or can be a different type of interface. As such, I/O interface 150 extends the capacity of such an interface when peripheral interface 152 and the I/O channel are of the same type, and the I/O interface translates information from a format suitable to such an interface to a format suitable to the peripheral channel 152 when they are of a different type. Add-on resource 154 can include a data storage system, an additional graphics interface, a network interface card (NIC), a sound/video processing card, another add-on resource, or a combination thereof. As an example, add-on resource 154 is connected to data storage system 190 via data storage system interface 192. Add-on resource 154 can be on a main circuit board, on separate circuit board or add-in card disposed within information handling system 100, a device that is external to the information handling system, or a combination thereof. Camera 156 is connected to light 159 via connection 194. Light 159 can be controlled to provide illumination of objects of which a photograph or video is being recorded using camera 156.

Network interface 170 represents a NIC disposed within information handling system 100, on a main circuit board of the information handling system, integrated onto another component such as chipset 120, in another suitable location, or a combination thereof. Network interface 170 is connected to I/O interface 150 via connection 174. Network interface device 170 includes network channel 172 that provides an interface to devices that are external to information handling system 100. In a particular embodiment, network channel 172 is of a different type than peripheral channel 152 and network interface 170 translates information from a format suitable to the peripheral channel to a format suitable to external devices. An example of network channels 172 includes InfiniBand channels, Fibre Channel channels, Gigabit Ethernet channels, proprietary channel architectures, or a combination thereof. Network channel 172 can be connected to external network resources (not illustrated). The network resource can include another information handling system, a data storage system, another network, a grid management system, another suitable resource, or a combination thereof.

In accordance with at least one embodiment, an information handling system includes instructions stored in memory 130 to be executed by processor 110. The instructions cause the processor 110 to receive a touch input from a touch screen display comprising video display 142 and touch controller 144. The instructions cause the processor 110 to determine a first axial motion element of the touch input. The first axial element of the touch input is aligned with a first axis. The instructions cause the processor 110 to select a first depth image from a plurality of depth images in response to the first axial motion element. The instructions cause the processor 110 to determine a second axial motion element of the touch input. The second axial motion element is aligned with a second axis. The second axis is at an angle relative to the first axis. As an example, the first axis and the second axis may be orthogonal axes of a rectilinear touch screen display, such that the first axis is perpendicular to the second axis. As another example, the first axis and the second axis may be at a non-perpendicular angle to each other. For example, one of the first axis and the second axis may be oriented along an axis of a touch screen display, while the other axis may be aligned with an axis leading toward a vanishing point of an image displayed on the touch screen display. The instructions cause the processor 110 to select additional depth images of the plurality of depth images in response to the second axial motion element. The additional depth images are proximate in depth to the first depth image. The instructions cause the processor 110 to apply an image processing filter to the first depth image and the additional depth images. The instructions cause the processor 110 to combine the first depth image and the additional depth images filtered by the image processing filter with other depth images of the plurality of depth images not filtered by the image processing filter to obtain a display image. The instructions cause the processor 110 to display a display image on the touch screen display.

In accordance with at least one embodiment, the instructions cause the processor 110 to apply the image processing filter selected from a group consisting of a color tone filter, an exposure filter, a contrast filter, and a sharpness or enhancement filter. In accordance with at least one embodiment, each of the depth images of the plurality of depth images has a width along an x axis and a height along a y axis and lies at a corresponding depth along a z axis away from a point of view. In accordance with at least one embodiment, the instructions cause the processor 110 to apply the image processing filter over the width and the height of the first depth image and the additional depth images. In accordance with at least one embodiment, the instructions cause the processor 110 to apply the image processing filter equally the first depth image and the additional depth images. In accordance with at least one embodiment, the instructions cause the processor 110 to apply the image processing filter to a greater degree to the first depth image and to a lesser degree to more distal ones of the additional depth images. In accordance with at least one embodiment, the instructions cause the processor 110 to receive the touch input representative of a sliding motion across the touch screen display.

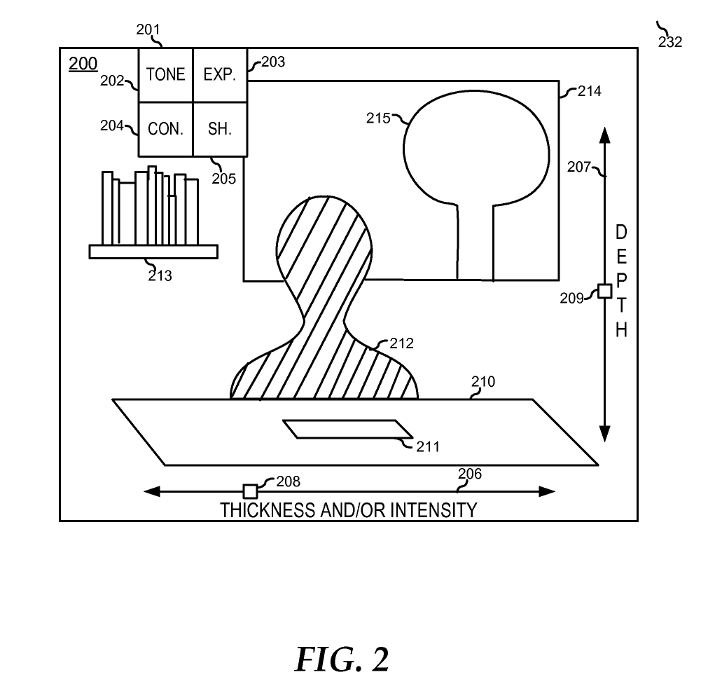

FIG. 2 is a display image diagram illustrating a graphic user interface (GUI) for receiving a touch input from a touch screen display and for displaying a display image on the touch screen display according to an embodiment of the present disclosure. GUI 200 comprises an image having image elements 210 through 214, a thickness control 208 operable over a thickness range 206, a depth control 209 operable over a depth range 207, and a menu 201. Menu 201 allows selection of a filter to be applied to image elements situated within a depth slice of the image being displayed. In the illustrated example, menu 201 comprises options for the selection of a tonal filter 202, an exposure filter 203, a contrast filter 204, and a sharpness and/or enhancement filter 205. For example, tonal filter 202 can filter based on color tone, such as sepia filter. As another example, exposure filter 203 can filter based on an exposure level so as to brighten or darken image elements within a selected image slice.

Depth control 209 allows selection of a depth within multiple depths of multiple depth images at which a depth slice of the image being displayed containing image elements to be selected to be filtered is situated. In the illustrated example, the selected depth corresponds to depth slice containing image element 212. As shown, image elements within the selected depth slice can be highlighted, for example, by displaying such image elements with altered tone or hue, such as by shading or altering the colors, or by outlining, flashing, pulsating, or otherwise providing such image elements with a distinctive appearance relative to other image elements at depths outside the selected depth slice. Such distinctive appearance need not be applied continuously. For example, the altered tone or hue can be restored to the normal tone or hue of the image during application of a selected filter so that the effect of the filter, such as tonal or exposure adjustment can be immediately observed without distortion of an altered tone or hue used for highlighting.

Thickness control 208 allows selection of a thickness of the selected depth slice. In the illustrated example, the selected thickness is toward the narrow end of thickness range 206, allowing selection of a depth slice containing image element 212, but not containing nearer or farther image elements, such as image elements 210, 211, 213, 214, and 215. By increasing the selected thickness of the selected depth slice using thickness control 208, image elements proximate in depth to image element 212 can be included within the selected depth slice. For example, with image element 212 representing a person behind image element 210, which represents a desk, on which image element 211, representing an electronic tablet, rests, with image element 213, representing a bookshelf, being on a wall behind the person represented by image element 212, thickness control 208 can be used to increase the thickness of the selected depth slice to include image elements 210, 211, and 213 proximate in depth to image element 212, but not image elements distal in depth to image element 212, such as image element 215, representing a tree, visible through a window represented by image element 214, with image element 212 in the selected image slice.

While thickness control 208 and depth control 209 are shown as visible, on-screen controls, thickness control 208 and depth control 209 may be implemented as contextual controls, where a touch input received from a touch screen display during a time period of interaction when selection of depth and thickness parameters for use in application of a filter is expected to occur is interpreted as providing the depth and thickness parameters that would otherwise be obtained from visible, on-screen controls. Such contextual controls can, for example, be used to allow thickness control 208 and depth control 209 to control parameters other than or additional to thickness and depth. As an example, a mode selection button (not shown) can be provided to select a mode in which thickness control 208 is used as a depth control and another mode in which thickness control 208 is used as a filter intensity control to control an intensity parameter to control a degree to which a selected filter is applied. The mode selection button can, for example, switch back and forth between such modes or, as another example, cycle through a larger plurality of modes. While one orientation of thickness control 208 and depth control 209 is shown, the orientations of thickness control and depth control 209 can be varied from what is shown. As an example, the position and orientation of thickness control 208 and depth control 209 can be interchanged. While thickness control 208 and depth control 209 are shown as discrete controls, both the depth and thickness parameters may be obtained from a common touch input. For example, vector analysis can be performed in response to a diagonal or rectilinear (e.g., L-shaped) touch input to determine a depth vector component along, for example, a y axis of the touch screen display and a thickness vector component along, for example, a x axis of the touch screen display. The depth vector component can be used to determine and apply a desired amount of depth change from a current depth to a selected depth so as to select the selected depth of a selected depth slice. The thickness vector component can be used to determine and apply a desired amount of thickness change from a current thickness to a selected thickness so as to select the selected thickness of the selected depth slice.

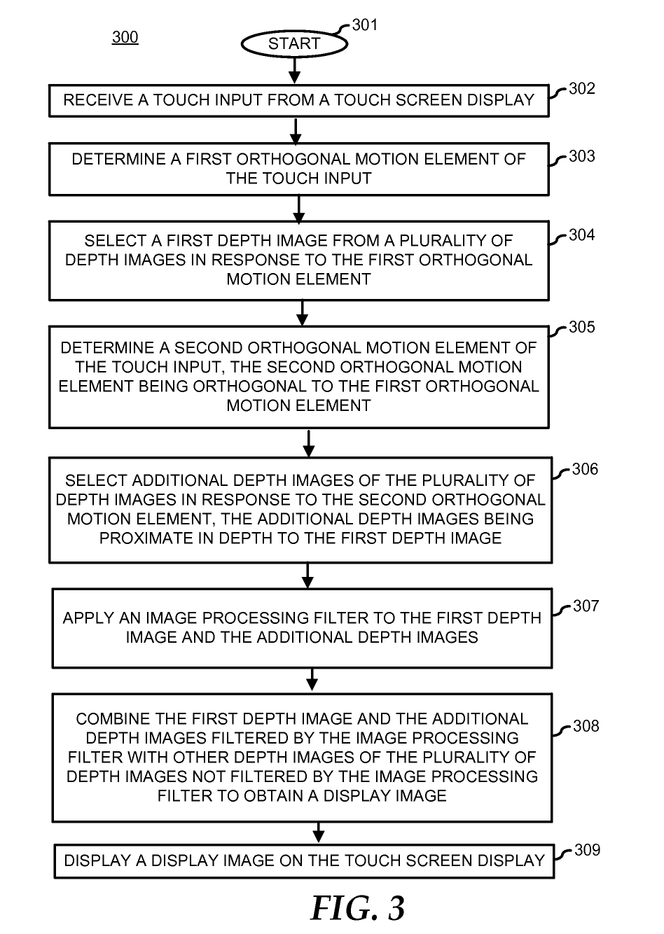

FIG. 3 is a flow diagram illustrating a method of filtering a portion of a plurality of depth images to obtain a display image according to an embodiment of the present disclosure. In accordance with at least one embodiment, a method is performed in an electronic information handling system. Method 300 begins in block 301. From block 301, method 300 continues to block 302. In block 302, a touch input is received from a touch screen display. From block 302, method 300 continues to block 303. In block 303, a first axial motion element of the touch input is determined. The first axial motion element is aligned with a first axis. From block 303, method 300 continues to block 304. In block 304, a first depth image is selected from a plurality of depth images in response to the first axial motion element. From block 304, method 300 continues to block 305. In block 305, a second axial motion element of the touch input is determined. The second axial motion element is aligned with a second axis. As an example, the first axis and the second axis may be orthogonal axes of a rectilinear touch screen display, such that the first axis is perpendicular to the second axis. As another example, the first axis and the second axis may be at a non-perpendicular angle to each other. For example, one of the first axis and the second axis may be oriented along an axis of a rectilinear touch screen display, while the other axis may be aligned with an axis leading toward a vanishing point of an image displayed on the touch screen display. The second axis is at an angle relative to the first axis. From block 305, method 300 continues to block 306. In block 306, additional depth images of the plurality of depth images are selected in response to the second axial motion element. The additional depth images are proximate in depth to the first depth image. From block 306, method 300 continues to block 307. In block 307, an image processing filter is applied to the first depth image and the additional depth images. From block 307, method 300 continues to block 308. In block 308, the first depth image and the additional depth images filtered by the image processing filter are combined with other depth images of the plurality of depth images not filtered by the image processing filter to obtain a display image. From block 308, method 300 continues to block 309. In block 309, a display image is displayed on the touch screen display.

In accordance with at least one embodiment, the applying the image processing filter comprises applying the image processing filter selected from a group consisting of a color tone filter, an exposure filter, a contrast filter, and a sharpness filter. In accordance with at least one embodiment, each of the depth images of the plurality of depth images has a width along an x axis and a height along a y axis and lies at a corresponding depth along a z axis away from a point of view. In accordance with at least one embodiment, applying the image processing filter to the first depth image and the additional depth images comprises applying the image processing filter over the width and the height of the first depth image and the additional depth images. In accordance with at least one embodiment, applying the image processing filter to the first depth image and the additional depth images comprises applying the image processing filter equally the first depth image and the additional depth images. In accordance with at least one embodiment, applying the image processing filter to the first depth image and the additional depth images comprises applying the image processing filter to a greater degree to the first depth image and to a lesser degree to more distal ones of the additional depth images. In accordance with at least one embodiment, the receiving the touch input from the touch screen display comprises receiving the touch input representative of a sliding motion across the touch screen display.

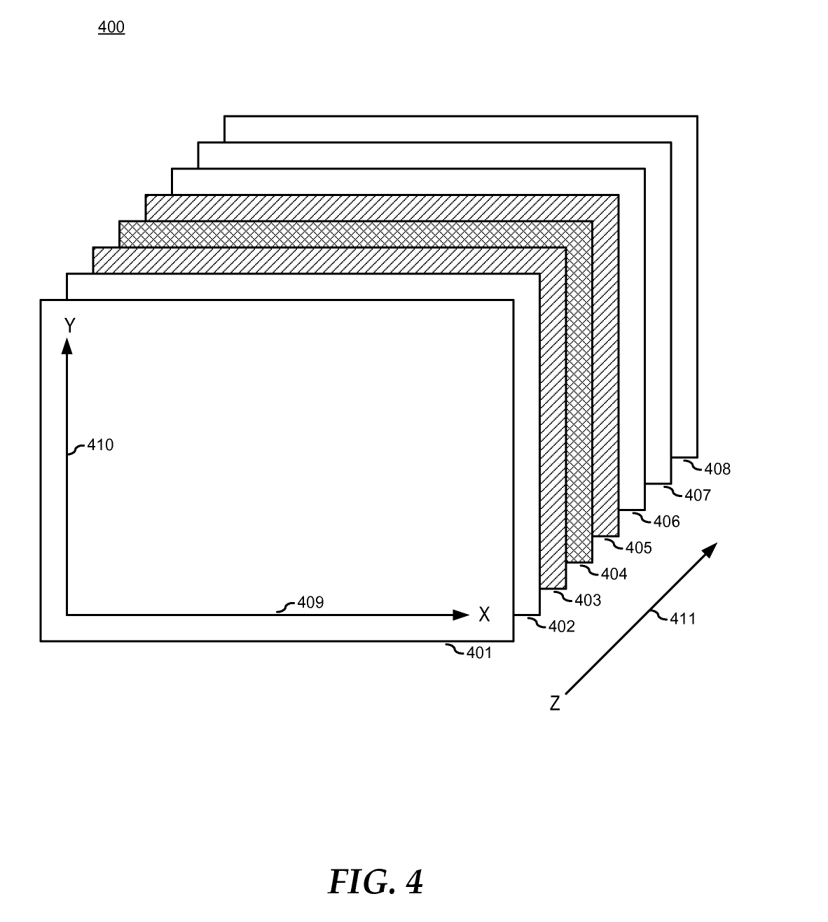

FIG. 4 is a block diagram illustrating a plurality of depth images and their relative spatial relationships according to an embodiment of the present disclosure. In the illustrated example, plurality of depth images 400 comprises depth images 401 through 408. Depth images 401 through 408 are illustrated relative to x axis 409, y axis 410, and z axis 411. As shown by crosshatching, a depth image 404 has been selected as a selected depth image. As further shown by shading of adjacent depth images 403, which is nearer to a point of view, and 405, which is farther from a point of view, a thickness sufficient to include depth images 403, 404, and 405 has been selected. Accordingly, a selected filter will be applied to depth images 403, 404, and 405, but not to non-selected depth images 401, 402, 406, 407, and 408. As described above with respect to FIG. 2, a depth control may be used to move a selected depth along z axis 411 to be nearer or farther from a point of view than depth image 404. For example, the depth control may be used to move the selected depth to be farther from the point of view so as to select depth image 405 as the selected depth image instead of depth image 404. If the selected thickness remains unchanged, then selection of depth image 405 would also select depth images 404 and 406 as being within the selected depth slice, as depth images 404 and 406 are similarly proximate in depth to newly selected depth image 405 as depth images 403 and 405 were to selected depth image 404.

The application of a filter within a selected depth slice may be uniform over the extent of the selected depth slice in the x, y, and z directions, or the filter may be applied non-uniformly over the selected depth slice. As one example, to provide a more gradual transition between the application of the filter to selected depth image 404 and the non-application of the filter to non-selected depth images 402 and 406 in the illustrated example, the degree to which the filter is applied may be tapered to lesser degrees for depth images within the selected depth slice that are less proximate to selected depth image 404. For example, if an exposure filter were selected to brighten the selected depth slice relative to the non-selected depth images, the full degree to which the exposure filter is selected to brighten selected depth image 404 may be applied to fully brighten selected depth image 404, while the exposure filter may be applied to a lesser degree to depth images 403 and 405 within the selected depth slice. If the selected thickness were increased to include depth images 402 and 406 within the selected depth slice, the exposure filter could be applied to an even lesser degree to depth images 402 and 406, as they are less proximate to selected depth image 404 than depth images 403 and 405.

As another example of how a filter may be applied non-uniformly over a selected depth slice, an area may be defined with respect to x axis 409 and y axis 410 within the selected depth slice to spatially limit the application of the selected filter. The selection of such an area may be defined using a contextual control. For example, a user may indicate that filtering, generically defined, is to be performed. Touch input may then be received to allow the user to define the area with respect to x axis 409 and y axis 410 over which a filter is to be applied. Touch input may then be received to allow the user to define a depth and thickness of a depth slice of depth images over which the filter is to be applied. Touch input may then be received to allow the user to select a filter to be applied. Touch input may then be received to allow the user to select one or more parameters of the filter, such as an intensity, governing how the filter is to be applied. By accepting sequential touch inputs in accordance with an expected sequence, many parameters can be specified using a series of simple gestures via the touch screen display. As another example, one or more mode selection buttons can be provided to alter the mode of a user control, such as a swipe motion touch input on a touch screen display, so that one or more axial components of the swipe motion touch input provides a different type of control that it otherwise would.

The plurality of depth images illustrated in FIG. 4 can be obtained using multiple photographic techniques. As an example, the plurality of depth images can be obtained by taking multiple exposures using a camera having a focusable lens to yield differences in sharpness at different distances, which can be used to determine distances of image elements from the camera and to construct depth images. As another example, the plurality of depth images can be obtained by taking multiple exposures using a camera having multiple camera elements at diverse locations to yield parallax information, which can be used to determine distances of image elements from the camera and to construct depth images. As yet another example, the plurality of depth images can be obtained using other techniques, such as constructing a plurality of depth images using image editing software, or with another mode of 3D data acquisition, such as a time-of-flight camera, a structured light camera, or any other 3D camera known in the art.

In accordance with at least one embodiment, an article of manufacture comprises a nontransitory storage medium for storing instructions executable by a processor. The instructions, when executed by the processor, cause the processor to receive a touch input from a touch screen display. The instructions, when executed by the processor, cause the processor to determine a first axial motion element of the touch input. The first axial motion element is aligned with a first axis. The instructions, when executed by the processor, cause the processor, to select a first depth image from a plurality of depth images in response to the first axial motion element. The instructions, when executed by the processor, cause the processor to determine a second axial motion element of the touch input. The second axial motion element is aligned with a second axis. The second axis is at an angle relative to the first axis. As an example, the first axis and the second axis may be orthogonal axes of a rectilinear touch screen display, such that the first axis is perpendicular to the second axis. As another example, the first axis and the second axis may be at a non-perpendicular angle to each other. For example, one of the first axis and the second axis may be oriented along an axis of a rectilinear touch screen display, while the other axis may be aligned with an axis leading toward a vanishing point of an image displayed on the touch screen display. The instructions, when executed by the processor, cause the processor to select additional depth images of the plurality of depth images in response to the second axial motion element. The additional depth images are proximate in depth to the first depth image. The instructions, when executed by the processor, cause the processor to apply an image processing filter to the first depth image and the additional depth images. The instructions, when executed by the processor, cause the processor to combine the first depth image and the additional depth images filtered by the image processing filter with other depth images of the plurality of depth images not filtered by the image processing filter to obtain a display image. The instructions, when executed by the processor, cause the processor to display a display image on the touch screen display.

In accordance with at least one embodiment, the instructions, when executed by the processor, further cause the processor to apply the image processing filter selected from a group consisting of a color tone filter, an exposure filter, a contrast filter, and a sharpness filter. In accordance with at least one embodiment, each of the depth images of the plurality of depth images has a width along an x axis and a height along a y axis and lies at a corresponding depth along a z axis away from a point of view. In accordance with at least one embodiment, the instructions, when executed by the processor, further cause the processor to apply the image processing filter over the width and the height of the first depth image and the additional depth images. In accordance with at least one embodiment, the instructions, when executed by the processor, further cause the processor to apply the image processing filter equally the first depth image and the additional depth images. In accordance with at least one embodiment, the instructions, when executed by the processor, further cause the processor to apply the image processing filter to a greater degree to the first depth image and to a lesser degree to more distal ones of the additional depth images.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method in an electronic information handling system comprising:
receiving a touch input from a touch screen display;
determining a first axial motion element of the touch input, the first axial motion element being aligned with a first axis;
selecting a first depth image from a plurality of depth images in response to the first axial motion element;
determining a second axial motion element of the touch input, the second axial motion element being aligned with a second axis, the second axis being at an angle relative to the first axis;
selecting additional depth images of the plurality of depth images in response to the second axial motion element, the additional depth images being proximate in depth to the first depth image;
applying an image processing filter to the first depth image and the additional depth images;
combining the first depth image and the additional depth images filtered by the image processing filter with other depth images of the plurality of depth images not filtered by the image processing filter to obtain a display image; and
displaying a display image on the touch screen display.

2. The method of claim 1 wherein the applying the image processing filter comprises:
applying the image processing filter selected from a group consisting of a color tone filter, an exposure filter, a contrast filter, and a sharpness filter.

3. The method of claim 1 wherein each of the depth images of the plurality of depth images has a width along an x axis and a height along a y axis and lies at a corresponding depth along a z axis away from a point of view.

4. The method of claim 3 wherein applying the image processing filter to the first depth image and the additional depth images comprises:
applying the image processing filter over the width and the height of the first depth image and the additional depth images.

5. The method of claim 1 wherein applying the image processing filter to the first depth image and the additional depth images comprises:
applying the image processing filter equally the first depth image and the additional depth images.

6. The method of claim 1 wherein applying the image processing filter to the first depth image and the additional depth images comprises:
applying the image processing filter to a greater degree to the first depth image and to a lesser degree to more distal ones of the additional depth images.

7. The method of claim 1 wherein the receiving the touch input from the touch screen display comprises:
receiving the touch input representative of a sliding motion across the touch screen display.

8. An information handling system comprising:
a touch screen display having a video display and a touch controller;
a processor;
and memory, the memory for storing instructions, the instructions, when executed by the processor, for causing the processor to receive a touch input from a touch screen display, to determine a first axial motion element of the touch input, the first axial motion element being aligned with a first axis, to select a first depth image from a plurality of depth images in response to the first axial motion element, to determine a second axial motion element of the touch input, the second axial motion element being aligned with a second axis, the second axis being at an angle relative to the first axis, to select additional depth images of the plurality of depth images in response to the second axial motion element, the additional depth images being proximate in depth to the first depth image, to apply an image processing filter to the first depth image and the additional depth images, to combine the first depth image and the additional depth images filtered by the image processing filter with other depth images of the plurality of depth images not filtered by the image processing filter to obtain a display image, and to display a display image on the touch screen display.

9. The information handling system of claim 8 wherein the instructions, when executed by the processor, further cause the processor to apply the image processing filter selected from a group consisting of a color tone filter, an exposure filter, a contrast filter, and a sharpness filter.

10. The information handling system of claim 8 wherein each of the depth images of the plurality of depth images has a width along an x axis and a height along a y axis and lies at a corresponding depth along a z axis away from a point of view.

11. The information handling system of claim 8 wherein the instructions, when executed by the processor, further cause the processor to apply the image processing filter over the width and the height of the first depth image and the additional depth images.

12. The information handling system of claim 8 wherein the instructions, when executed by the processor, further cause the processor to apply the image processing filter equally the first depth image and the additional depth images.

13. The information handling system of claim 8 wherein the instructions, when executed by the processor, further cause the processor to apply the image processing filter to a greater degree to the first depth image and to a lesser degree to more distal ones of the additional depth images.

14. The information handling system of claim 8 wherein the instructions, when executed by the processor, further cause the processor to receive the touch input representative of a sliding motion across the touch screen display.

15. An article of manufacture comprising:
a nontransitory storage medium for storing instructions executable by a processor, the instructions, when executed by the processor, for causing the processor to receive a touch input from a touch screen display, to determine a first axial motion element of the touch input, the first axial motion element being aligned with a first axis, to select a first depth image from a plurality of depth images in response to the first axial motion element, to determine a second axial motion element of the touch input, the second axial motion element being aligned with a second axis, the second axis being at an angle relative to the first axis, to select additional depth images of the plurality of depth images in response to the second axial motion element, the additional depth images being proximate in depth to the first depth image, to apply an image processing filter to the first depth image and the additional depth images, to combine the first depth image and the additional depth images filtered by the image processing filter with other depth images of the plurality of depth images not filtered by the image processing filter to obtain a display image, and to display a display image on the touch screen display.

16. The article of manufacture of claim 15 wherein the instructions, when executed by the processor, further cause the processor to apply the image processing filter selected from a group consisting of a color tone filter, an exposure filter, a contrast filter, and a sharpness filter.

17. The article of manufacture of claim 15 wherein each of the depth images of the plurality of depth images has a width along an x axis and a height along a y axis and lies at a corresponding depth along a z axis away from a point of view.

18. The article of manufacture of claim 15 wherein the instructions, when executed by the processor, further cause the processor to apply the image processing filter over the width and the height of the first depth image and the additional depth images.

19. The article of manufacture of claim 15 wherein the instructions, when executed by the processor, further cause the processor to apply the image processing filter equally the first depth image and the additional depth images.

20. The article of manufacture of claim 15 wherein the instructions, when executed by the processor, further cause the processor to apply the image processing filter to a greater degree to the first depth image and to a lesser degree to more distal ones of the additional depth images.
